(19) United States
(12) Patent Application Publication
(10) Pub. No.: US 2012/0173969 A1
(43) Pub. Date: Jul. 5, 2012

(54) Master Templates For Document Generation

(76) Inventors: Klemens Schmid, Wiesloch (DE); Frank Erle, Schriesheim (DE); Saikrishna Gollapudi, Bangalore (IN); Visvapriya Sathiyam, Bangalore (IN); Zifeng Gu, Shanghai (CN); Christoph Birkenhauer, Wiesloch (DE); Karsten Fanghaenel, Schwetzingen (DE); Jun Wu, Shanghai (CN); Pramod P. K., Bangalore (IN); Praveen Srivastava, Bangalore (IN); Sathish Babu Krishna Vihar, Bangalore (IN); Andre Stern, Ladenburg (DE)

(21) Appl. No.: 13/187,368

(22) Filed: Jul. 20, 2011

(30) Foreign Application Priority Data
Dec. 31, 2010 (CN) 201010618048.0

(51) Int. Cl. G06F 17/20

(52) U.S. Cl. 715/246

(57) ABSTRACT

Disclosed are methods, systems and products, including a computer implemented method that includes obtaining by at least one of a plurality of entities at least one master template available to the plurality of entities to generate documents from the at least one master template. The at least one master template includes at least one template area, with each of the at least one template area being associated with a respective data type. The method also includes generating a document by the at least one of the plurality of entities based, at least in part, on the at least one master template using entity-specific data associated with the at least one of the plurality of entities for the data type associated with the at least one template area.

### CROSS REFERENCE TO RELATED APPLICATION

This application claims the benefit under 35 U.S.C. §119(e) of the following Chinese Application Serial No. 201010618048.0 filed on Dec. 31, 2010, entitled “Master Templates For Document Generation” all of which is incorporated herein by reference in its entirety.

### BACKGROUND

The present disclosure relates to document production and management, and more particularly to master templates for document generation.

Enterprises (e.g., conglomerates comprising related, but possibly independent companies) may wish to apply a unified corporate style and layout to all outgoing documents. This may particularly be the case in relation to documents created by software systems run by the enterprise or on its behalf. In situations where the software system serves multiple independent companies document layout may need to be company specific, while potentially still having to conform to a standard basic layout, configuration and formatting features adopted enterprise-wide. Conventional document production schemes/systems achieve company-specific layout of outgoing documents by using document templates for each individual scenario and for each individual company. As there may be a large variety of such documents, the effort to individually adapt all these documents to the corporate basic layout/configuration/formatting/design features may be significant.

### SUMMARY

In one aspect, a computer implemented method is disclosed. The method includes obtaining by at least one of a plurality of entities at least one master template available to the plurality of entities to generate documents from the at least one master template. The at least one master template includes at least one template area, with each of the at least one template area being associated with a respective data type. The method also includes generating a document by the at least one of the plurality of entities based, at least in part, on the at least one master template using entity-specific data associated with the at least one of the plurality of entities for the data type associated with the at least one template area.

Embodiments of the method may include any of the features described in the present disclosure, including any of the following features.

The plurality of entities may include a plurality of clients, and the obtaining and generating may be implemented using at least one processor-based device.

Generating the document may include generating the document using at least the at least one master template populated with the data associated with the at least one of the plurality of entities for the data type associated with the at least one template area.

Generating the document may include merging the populated at least one master template with additional raw data provided by the at least one of the plurality of entities.

The additional raw data may be document content.

The generated document may include at least one of, for example, an e-mail, a facsimile, a form, a report, a business document, and/or a letter.

The at least one master template may include information, corresponding to the at least one template area, that is common to at least some of the plurality of entities, with the common information including information representative of at least one of, for example, common document layout, common text modules, common coloring formatting, and/or common document styles.

The common information of the at least one master template may be arranged in a master document such that the entity-specific data is populated directly onto the master document.

The common information of the at least one master template may be arranged as a set of attributes such that a resultant document is generated based, at least in part, on the set of attributes and the entity-specific data.

In another aspect, a system is disclosed. The system includes at least one processor-based device, and at least one non-transitory memory storage device in communication with the at least one processor-based device. The at least one memory storage device stores computer instructions that, when executed on the at least one processor-based device, cause the at least one processor-based device to obtain by at least one of a plurality of entities at least one master template available to the plurality of entities to generate documents from the at least one master template. The at least one master template includes at least one template area, with each of the at least one template area being associated with a respective data type. The computer instructions also cause the at least one processor-based device to generate a document by the at least one of the plurality of entities based, at least in part, on the at least one master template using entity-specific data associated with the at least one of the plurality of entities for the data type associated with the at least one template area.

Embodiments of the system may include any of the features described in the present disclosure, including any of the features described above in relation to the method, and the features described below.

In a further aspect, a computer program product is disclosed. The computer program product includes at least one non-transitory computer readable storage device storing computer instructions that, when executed on at least one processor-based device, cause the at least one processor-based device to perform operations including obtaining by at least one of a plurality of entities at least one master template available to the plurality of entities to generate documents from the at least one master template. The at least one master template includes at least one template area, with each of the at least one template area being associated with a respective data type. The computer instructions also cause the at least one processor-based device to perform operations that include generating a document by the at least one of the plurality of entities based, at least in part, on the at least one master template using entity-specific data associated with the at least one of the plurality of entities for the data type associated with the at least one template area.

Embodiments of the computer program product may include any of the features described in the present disclosure, including any of the features described above in relation to the method and the system, and the features described below.

Details of one or more implementations are set forth in the accompanying drawings and in the description below. Further features, aspects, and advantages will become apparent from the description, the drawings, and the claims.

### BRIEF DESCRIPTION OF THE DRAWINGS

FIG. 1 is a schematic diagram of a computing environment that enables maintaining, managing, and using master templates for document generation.

FIG. 2A is a screenshot of an example master template to generate documents.

FIG. 2B is a screenshot of an example e-mail master template to generate e-mails is shown.

FIGS. 3A-G are screenshots of graphical user interfaces to control and manage master templates.

FIG. 4 is a schematic diagram of an example computing system that may be used in the implementation of any one of the various depicted systems/components/devices of FIG. 1.

FIG. 5 is a flowchart of an example procedure to maintain, manage, and use master templates for document generation.

Like reference numbers and designations in the various drawings indicate like elements.

### DETAILED DESCRIPTION

As described herein, in some implementations, the effort to adapt individual companies' document layout, configuration, and/or formatting to basic general enterprise requirements may be significantly lowered by introducing master templates for each document type. Such master templates may carry the corporate-specific document layout, text modules, coloring, styles, and other elements common to all documents of a specific type. In some embodiments, the master templates for a particular document type used enterprise-wide may be provided as actual documents relating to same document type. Additionally and/or alternatively, in some embodiments, the master templates for a particular document type may be provided as a set of attributes associated with the document type, or may be provided as individual sets of attributes that each corresponds to a document/company combination (e.g., for every entity belonging to an enterprise, sets of attributes corresponding to the various documents types may be maintained). In some embodiments, when creating an outgoing document a raw document may first be created, that is then merged with the master template (including one populated, at least partially, with entity-specific information) to produce the finalized outgoing document.

A master template may be used to specify the layout and generic content of a template. When business documents are opened on the system, the content can be populated depending on a form template. For example, when using an e-mail template specifying the inclusion of a disclaimer with outgoing e-mails, the corresponding master template for the e-mail disclaimer can cause a disclaimer to be appended when, for example, sending out a form template via e-mail.

Standard master templates may be provided for a variety of uses, including, for example, Excel templates, e-mails, various business documents (implemented, for example, using a business system, such as SAP™ ByDesign), etc. Authorized users of the accessing entities/clients can change the overall layout and content of these master templates to, for example, present more specific corporate identity during production of documents.

The master template technology described herein reduces the number of document templates by the factor of companies supported by (e.g., connected to) the enterprise-run computing/software system. The effort for the enterprise to adapt the layout of all documents at once is thus reduced. The effort to introduce documents for a new company is also reduced. In some embodiments, the methods/systems/apparatus/products described herein may be used for the following purposes:
Office Integration within a computing system (e.g., a computing system implemented using a business management system, such as SAP's Business ByDesign, or any other system for managing financials, customer relationships, human resources, projects, procurement, and/or a supply chain, architecture and configuration);
Forms processing within the computing system including forms used for printing, faxing, outgoing e-mail, etc.; and
E-mail outbound within the computing system.

Described herein are methods, systems, apparatus and computer program products, including a method that includes obtaining by at least one of a plurality of entities at least one master template available to the plurality of entities to generate documents from the at least one master template. The at least one master template includes at least one template area, with each of the at least one template area being associated with a respective data type. The method also includes generating a document by the at least one of the plurality of entities based, at least in part, on the at least one master template using entity-specific data associated with the at least one of the plurality of entities for the data type associated with the at least one template area.

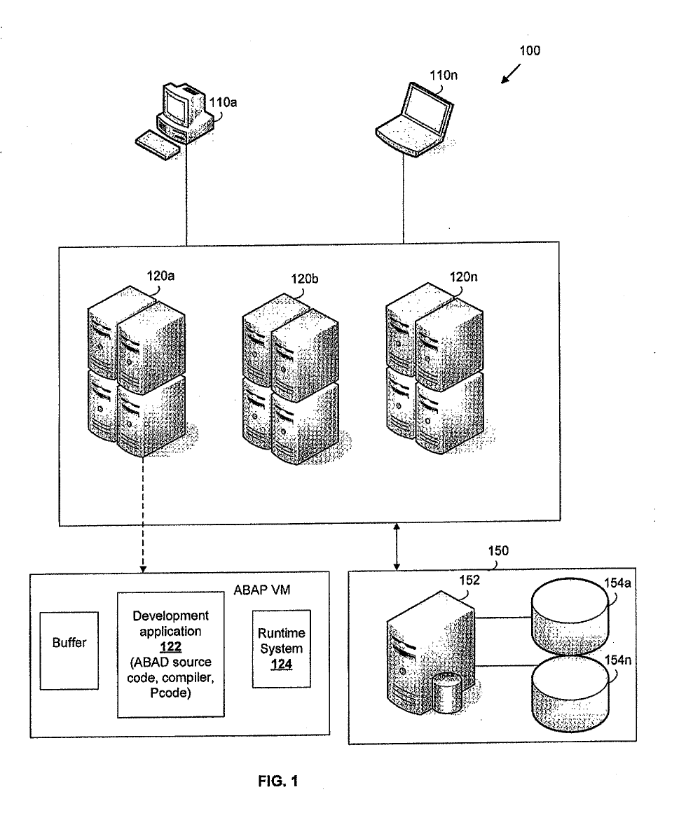

With reference to FIG. 1, a schematic diagram of a computing environment 100 which includes a service development application is shown. The computing environment 100 includes one or more clients, such as clients 110a-n, each of which may be executing remotely or locally and is in communication with one or more application servers, such as the application server 120a-n depicted in FIG. 1. Each of the clients 110a-n may constitute at least part of a local server serving at least one of a plurality of entities. Such entities can include different companies that may or may not be related to one another, or may include any type of user/client that can access any one of the application servers 120a-n. The one or more clients 110a-n are configured to enable users to provide input and receive data (displayable, for example, via local interfaces coupled to the respective clients 110a-n). The one or more clients 110a-n communicate with the one or more application servers 120a-n via, for example, direct wire-based links, network communication links, wireless communication links, etc.

The one or more application servers, including the servers 120a-n, form part of an “application layer.” Each application server may be executing a set of services (also referred to as “application services”) that process/serve users' requests. For example, a user, interacting with the application servers through, for example, one of the interfaces of the clients 110a-n, can submit a request for service by one or more of the applications on the one or more application servers 120a-n, that causes one or more instances of the applications required to serve the request to be invoked. In some embodiments, the application layer may include additional systems/components/modules, such as, for example, a message server (not shown in FIG. 1) to enable communication between the application servers (e.g., transmitting requests and data from one application server to another). In some implementations, a message server may monitor and manage information about the application servers, e.g., information such as current request loads and data traffic supported by the various servers.

The computing environment 100, via, for example, the application servers 120a-n, is configured to enable maintaining and/or generating master templates that can be accessed and used by clients, such as the clients 110a-n, to generate documents that include entity-specific information presented in accordance with layout/configuration/formatting requirements that are used enterprise-wide. Documents of a particular document type (e.g., an e-mail, a facsimile message, a particular form, such as a report, a sales order, etc.) generated for separate entities (associated with separate clients from the client s 110a-n) may include information common to all documents generated by the various entities for that particular document type. In some implementations, documents generated by separate entities will include common layout/configuration/formatting characteristics (e.g., a company logo located at a particular area of the document generated, a standard disclaimer at the footer area of the document, required font size and paragraph formatting at a particular area of the body of the document, etc.)

In some embodiments, each of a plurality of entities may obtain a copy (e.g., instance) of a master template for a particular document type, and use that obtained master template to generate one or more documents from the master template. The master template obtained by the entities may include at least one template area associated with a respective data type. The master template may include information specifying the layout/configuration/formatting of the document to be generated, e.g., location and type of information to be placed in the document to be generated. The at least one template area of the master template obtained may also include formatting information indicating how data to be placed in a document location corresponding to the template area is to be formatted. In some embodiments, the at least one template area may also include specific document content (e.g., enterprise-wide content) that is to be added to the document in the location corresponding to that template area.

Thus, an entity obtaining a master template may generate a document of a particular document type based on the master template obtained. In some implementations, the entity populates the template obtained (e.g., where the template is configured as a generic document including at least one template area) with entity specific data associated with the at least one of the plurality of entities for the data type associated with the at least one template area. Documents generated by different entities using the same master template will therefore have common layout/configuration/formatting characteristics.

As further shown in FIG. 1, in some embodiments, the computing environment 100 includes a database layer 150 comprising a database system to store and maintain data used by the applications servers 120, including a master template repository to maintain various master templates that may be used by clients and/or entities accessing the servers 120a-n. The database layer 150 may also include data repositories/databases to maintain and manage source code data, object code compiled from source code data, control and customizing data, business/transactional data, other types of content data, etc. The database system generally includes a data management application 152 (which may be executing locally or remotely) and one or more data storage devices 154a-n (i.e., memory devices, which may be distributed over a network), in which data relating to the objects to be managed is maintained. The data management application 152 may be a commercial or customized data management system, e.g., a database management application implemented in software and executing on processor-based servers. Microsoft SQL server is an example of a commercially available database management application. The database system 150 may also include a communications module to enable it to communicate with remote devices (e.g., wirelessly, through a network gateway connection, or through wired links).

In some embodiments, at least some of the clients 110a-n and/or the servers 120a-n may be implemented based on a “By Design” system architecture. A ByDesign system is generally a cloud-based system that enables a client at for example 110a to access core/central system resources on-demand. These core/central resources comprise business software-based systems hosted at a remote location in the cloud, e.g., accessed via the Internet. The ByDesign system includes a heterogeneous system of different subsystems providing a management system for managing financials, customer relationships, human resources, projects, procurement, and/or a supply chain. The ByDesign-based system may include a “central component(s)” located remotely in the so-called cloud. These central components are shared, for example, by clients, such as ABAP (Advanced Business Application Programming) client systems. For example, the clients 110a-b may be located at one or more user locations, but the server systems 120a-b and the database layer 150 may be accessed as a service on-demand via a cloud. Although ByDesign and cloud based software-as-a-service systems are noted herein, the subject matter described herein may be used in other systems as well.

The master templates used by the various entities that may access a master templates repository (implemented using, for example, the database layer 150) and that may be made available as records that include sets of attributes defining the templates' layout, formatting and/or configurations. Under such circumstances, entities wishing to use one or more of such templates can retrieve a copy or an instance of the records, and generate locally a document based on the record obtained that contains the layout/formatting/configuration attributes. Upon retrieval of the instance of the record with document attributes, a document generator (for example, a word processor application executing at a client's local machine) reads the record obtained and opens a new document configured according to the attributes specified in the retrieved record.

Alternatively and/or additionally, in some embodiments, the master templates may be generated and made available as documents in which the various layout/formatting/configuration attributes have already been pre-set in the documents. Under such circumstances, a client wishing to generate documents with entity-specific information may obtain (e.g., retrieve) a copy of the desired pre-set (pre-configured) document from the repository of master templates and add the entity-specific data at the entity's local machine. In some implementations, documents including entity-specific data may be generated at the central server by, for example, generating an instance of the document pre-configured based on enterprise-wide requirements at the central server, and adding entity-specific data to that instance of the pre-configured document.

Alternatively and/or additionally, in some embodiments, the master template may be configured as a pre-defined graphical user interface (GUI) with user-controlled input items (e.g., fields to enter input values, drop-down menus to present various selectable options, selectable buttons, etc.) to enable a client obtaining such a pre-defined GUI to specify the entity-specific attributes and data that are to be used to generate the entity-specific document. Here too, the pre-defined GUI may be communicated from the “cloud” (e.g., elements 120a-n, 150, and the like) to the client's local machine (e.g., the central server coupled to the master templates repository may send data to enable presentation of a master template interface by, for example, sending to the client's local computing device markup language data, scripted data, etc.) whereupon the pre-defined master template GUI will be instantiated at the client's local machine. Alternatively, the master template GUI may be instantiated at the central server with which the plurality of entities interact through their respective client machines (e.g., the clients 110a-n of FIG. 1). In either case, upon instantiation of the master-template GUI, a user at the client's machine may provide the input to more particularly define the document that is to be generated based on the template and the added user input.

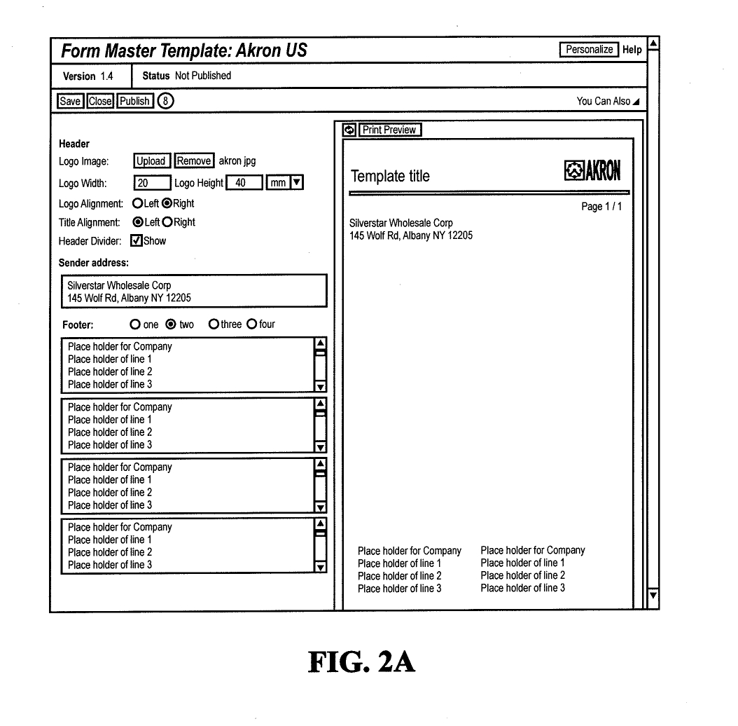

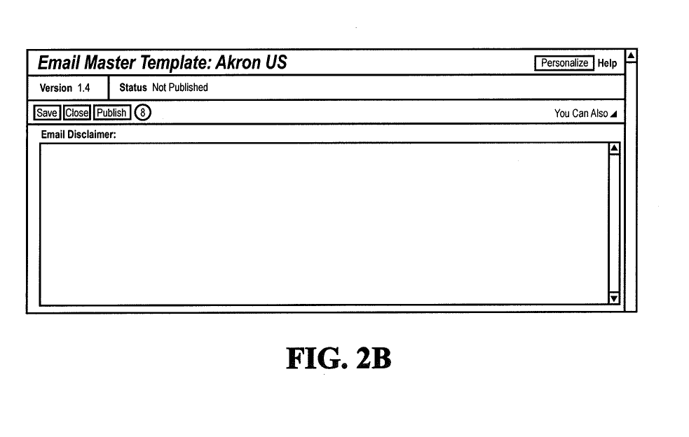

For example, and with reference to FIG. 2A, a screenshot (e.g., a hypertext markup language (HTML) page) of an example master template 200 for use to generate documents is shown. The master template of FIG. 2A is implemented, in this example, as a GUI that specifies general layout/configuration/formatting attributes that are to be common for all documents generated by various entities (e.g., at any of the various different clients' servers 110a-n), and enables users accessing this template to specify entity-specific document attributes. As shown, the master template 200, corresponding to a letter-type document, includes a header input area 210 with user-selectable items to specify client-specific attributes of the header area of the template, a sender address input area 220 through which the user may be provide addressee information, and a footer input area 230 with user-selectable items to enable the user to enter entity-specific attributes and data in relation to the footer area of the template (and thus of the document to be generated). The master template also includes, in some embodiments, a document preview area 240 in which a graphical representation of the document to be generated, based on the template 200 and user-provided input, is presented.

In the example of FIG. 2A, the master template 200 defines the layout, configuration, and/or formatting of the header and footer areas of the document, e.g., the respective locations and sizes of the header area and footer area, and enables the user interacting with the master template 200 to specify some entity-specific characteristics of the document to be generated. For example, the user can provide input regarding the location and sizes of a logo to be placed in the header using user-selectable items 212a-f. It is to be noted that master template 200 prevents a user, in this example, from adding the logo elsewhere in the document to be generated. Thus, when the master template 200 is used by various different entities that can access it, all documents generated will share the common layout/configuration/ formatting attributes of the header and footer areas defined in the master template 200, including the pre-defined sizes of the header and footer areas, and the fact that a logo can be added to the header. However, different entities may control some of the details of the document's layout and configuration. For example, the entities accessing this template 200 may specify the number and content of different footer sub-areas to be provided within the document to be generated. In this example, a user interacting with the template 200 can specify, by clicking user selectable item 232, that two separate footer sub-areas are to be defined within the footer area of the document (corresponding to the footer area 244 in the preview area of the document). However, the user cannot specify the exact locations of where those footer sub-areas would be positioned within the footer area. Rather, the positions of the two footer sub-areas are, in this example, pre-determined and are common to all documents of this type that are to be generated by different entities. When the user selects the number of footer sub-areas to be included within the footer area, the user-selectable items within the template's input area 230 corresponding to the two sub-areas are enabled (e.g., user-selectable input items 234a-b, while the other user-selectable items (e.g., items 236a-b) for the other sub-areas are disabled.

In some embodiments, after a user associated with one entity specifies entity-specific attributes for the master template, the resultant modified template may be stored (e.g., by clicking on the “save” button at the top of the template 200) in the master templates repository implemented, for example, at the database layer 150 of the computing environment 100 of FIG. 1, and thereafter be used as another master template for use by other entities (which may be a subset of the entities that can access the master template from which the new resultant master template was prepared). In some embodiments, the modified template may be stored for subsequent use as a new master template at the corresponding local client server.

In some embodiments, the entities retrieving and manipulating the master template may designate key users (e.g., a group of select authorized users) to control and manipulate master templates (for example, to populate master templates available to various entities with entity-specific layout/configuration/formatting information that can then be stored as a resultant modified entity-specific master template). Thus, in such embodiments, a key user for a particular entity may be responsible for, with respect to a master template such as the one depicted in FIG. 2A, uploading a logo, defining its alignment, and adding a static sender address and up to four footers. The key user may also be authorized to set up, for example, the page numbering format and appearance on first page and subsequent pages. Key users may set up templates to be entity-compliant (e.g., corporate compliant where the entity in question is a corporation), and to meet the entity's special requirements.

With reference now to FIG. 2B, a screenshot of an example e-mail master template 250 to generate e-mails is shown. The template 250 provides that e-mails generated by different entities accessing this template will include a disclaimer portion. The template 250, which like the template 200 of FIG. 2A may be a GUI-based master template, enables accessing entities to control the specific disclaimer content that is to be added to e-mail generated by the various accessing entities. However, in this example, the entities cannot specify, for example, the positioning of the disclaimer within a generated e-mail. In some embodiment, the template 250 may enable entities to specify the disclaimer that is to be added to e-mails that include generated documents as attachments (e.g., in situations where the application through which a particular document was generated includes a feature of e-mailing the document to a destination party).

In some embodiments, to generate documents using master templates, specialized document-generating applications may be used. For example, such application may be implemented using GUI-based templates such as those shown in FIGS. 2A and 2B. In such implementations, upon entry of client-specific data and layout/configuration/formatting attributes, the user may click on a “generate” or “publish” button (such as a “publish” button 202 shown in FIG. 2A) to cause a resultant document to be generated based on the template and the entity-specific information entered by the user into the appropriate input areas of the template.

In some embodiments, the data provided by the user may also include the actual “raw” data (e.g., content) of the document. Such raw data may be provided prior to the actual generation (publication) of the document using the master template. For example, GUI-based templates may also include input areas to receive a user's raw data input, and upon generation of the document, the raw data would be populated into the resultant document. In some embodiments, the document having the entity-specific layout/configuration/formatting information may be generated first, and subsequently the user can add the raw data to the generated documents. Thus, generating the document may include generating the document using the master template, and having the generated document populated with data associated with the entity that generated the document.

In some embodiments, generating the document may include merging a document generated from the master template populated with entity-specific data (e.g., data pertaining to client-specific layout/configuration/formatting information) with additional raw data, such as actual document content data. Thus, in such embodiments, two separate documents, one with layout/configuration/formatting data and one with content data, may be merged.

As noted, in some embodiments, the master templates accessible by a plurality of entities may be stored in a central repository, such as the repository implemented using the database layer 150 of the computing environment 100 depicted in FIG. 1. For example, master templates may be managed as part of an “on-demand” solution and stored per tenant in a central repository (that is generally remote from the clients' servers). Those master templates may be maintained and managed together with, for example, actual templates (e.g., more detailed templates generated from the master templates) that are used to generate resultant output documents. Alternatively, the templates may be maintained and managed at distributed repositories that may be local or remote (e.g., in the cloud and provided as a service on-demand) to the client servers through which the entities access the templates. Different types of methodologies to arrange the data relating to the master templates may be used.

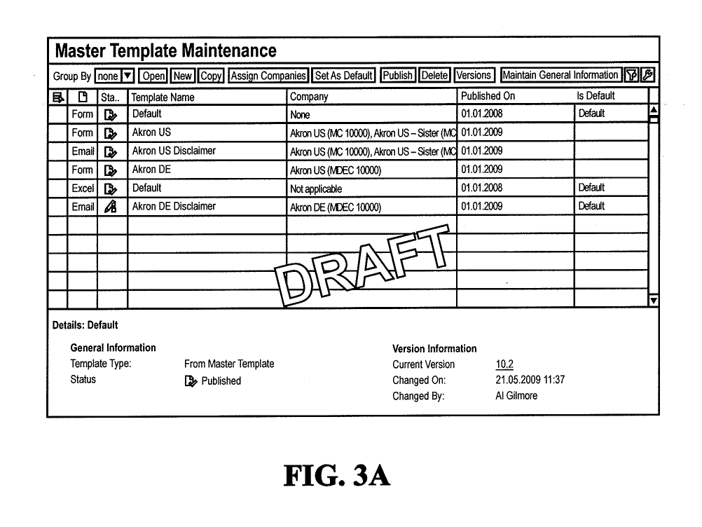

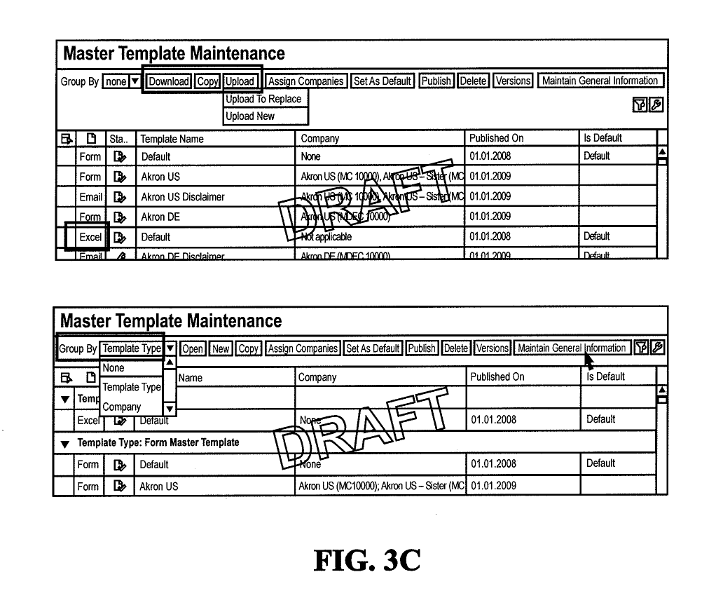

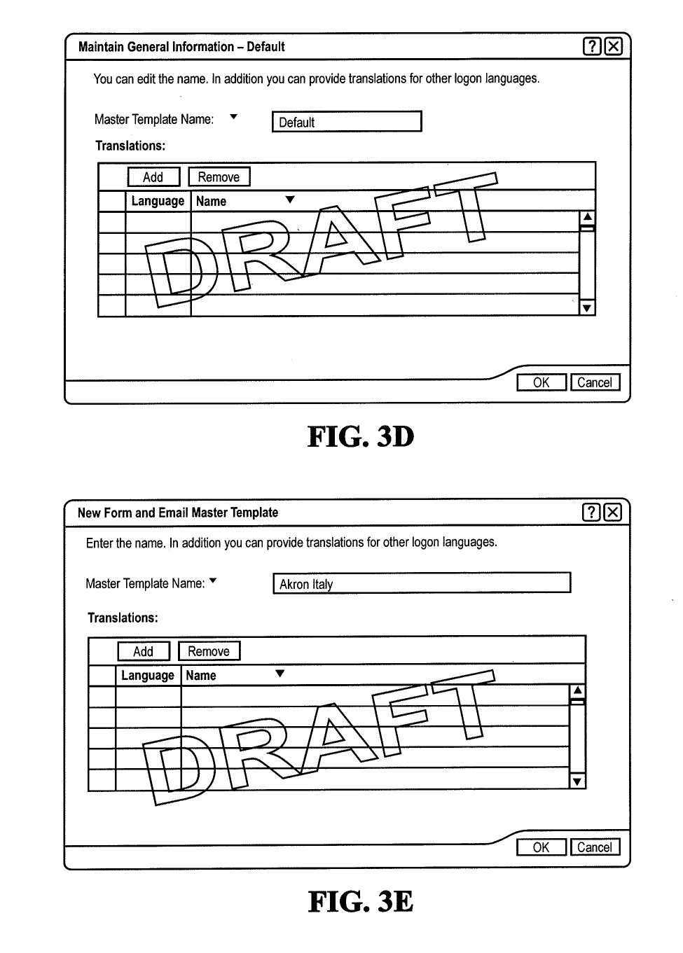

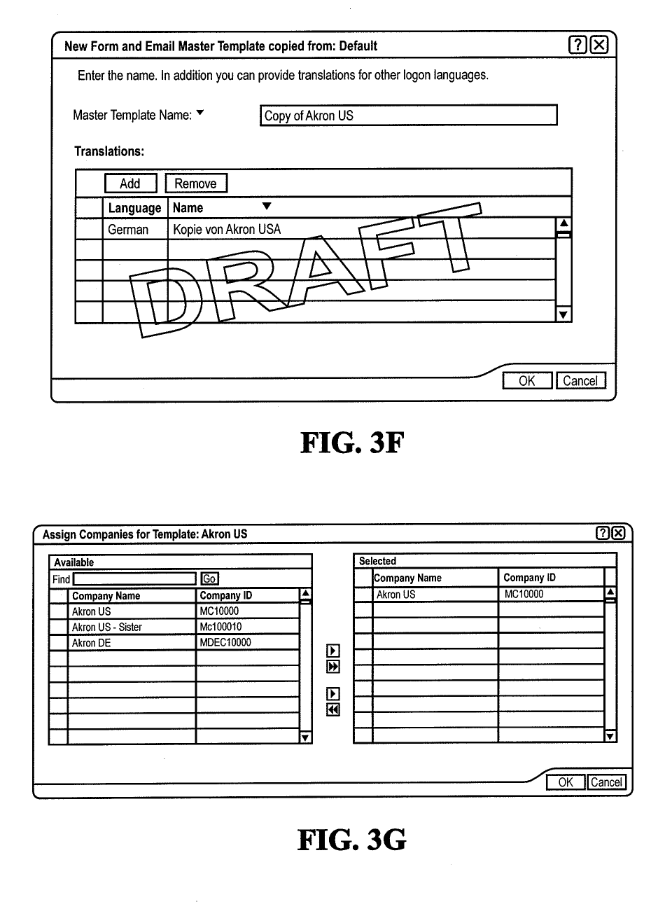

Control and management of the master template may be performed via one or more graphical user interfaces, such as the interfaces shown in the screenshot of FIGS. 3A-G. More particularly, with reference to FIG. 3A, a screenshot of an example interface 300 to provide and manage general information relating to master templates is shown. The interface 300 includes a selectable button 301 to enable the user to perform a grouping operation on the master template (according to one or more criteria that can be selected from a drop-down menu), a button 302 to open a master template to obtain more details regarding a template(s) and/or modify the template's information, a button 303 to assign companies that may access and obtain a copy (instance) of a selected one or more master templates (see also FIG. 3G), and additional operations such as setting default templates, deleting templates, etc.

As shown in FIG. 3B, which is a screenshot of an example interface 310 to provide and manage information in relation to master templates maintained in a repository, in some embodiments, the type of operations available to manage the master template may depend on the type of template that is being considered. For example, when the templates selected through the interface 310 is an Excel master template, different template management operations may be enabled that are not available for other types of templates. In the example of FIG. 3B, the selection of the “Default” Excel template (as indicated by the highlighted row 312 of FIG. 3B) causes operations 314, which include the download, copy and upload operations, to be made available from the cloud to a client machine, such as clients 110a-n. These operations are not required when other templates (such as the “Default” form template selected in FIG. 3A) are being managed.

With reference now to FIG. 3C, a screenshot of an example interface 320 (which may be similar to the interface 300 of FIG. 3A) to manage master templates is shown. As illustrated in FIG. 3C, in response to selection of a grouping operation, a dropdown menu 322 is provided to enable a user to group one or more templates according to various criteria that include, for example, template type, assigned company, etc.

With reference to FIG. 3D, a screenshot of an example interface 330 to maintain general information is shown. In some embodiments, the interface 330 enables users to change, for example, template names in various languages, and/or other metadata-type information associated with the template. The interface 330 thus enables users to change line item information pertaining to selected templates from the master template list. Generally, the interface 330 may not enable users to change the contents of the selected template(s) from the template list, or change the presentation/ formatting attributes of the templates, such as the fonts, layout, configuration, etc., of the selected templates (in some implementations, the content and/or formatting attributes of the templates may be controlled and varied using a dedicated interface, such as the interface 200 of FIG. 2A, to edit the content and formatting of the master templates).

With reference to FIG. 3E, a screenshot of an example interface 340 to create new templates is shown. As illustrated, the interface prompts a user to enter a name of a template. Upon entry of a name, the user would be led to additional interface views to enable the user to define/specify the layout/configuration/formatting attributes of the new master template that is being formed. Subsequently, in some embodiments, another interface (e.g., an interface with editing functionality, such as the interface 200 of FIG. 2A) may be used to control the content and attributes of the newly created template, and/or to generate a resultant output document. FIG. 3F is a screenshot of an example interface 350 to enable performing a template copying operation (e.g., to replicate a template so as to create, for example, another instance of the template that can be modified to provide another master template).

Lastly, as noted, master templates can be selectively assigned to entities so that only specified entities assigned to a particular template may access and use the assigned master template to generate documents therefrom. Thus, with reference to FIG. 3G, a screenshot of an example interface 360 to assign selected entities (e.g., companies) to a particular master template is shown. In some embodiments, the interface 360 may have been invoked through selection of an assignment operation from a parent interface (e.g., by clicking the button 303 of the example interface 300 illustrated in FIG. 3A). As shown in FIG. 3G, in response to a selection of a particular template (e.g., the template entitled “Akron US” in the example of FIG. 3G), an interface, such as the interface 360, is invoked to present, with respect to that template, what entities (companies) are already assigned to that template (as shown in table 364 of the template interface 360), as well as what entities (companies) may be available for assignment of the template thereto (as shown in table 362 of the template interface 360). Subsequently, one or more of the entities indicated in the table 362 may be assigned to the template in question (e.g., by clicking the “OK” on the template interface 360).

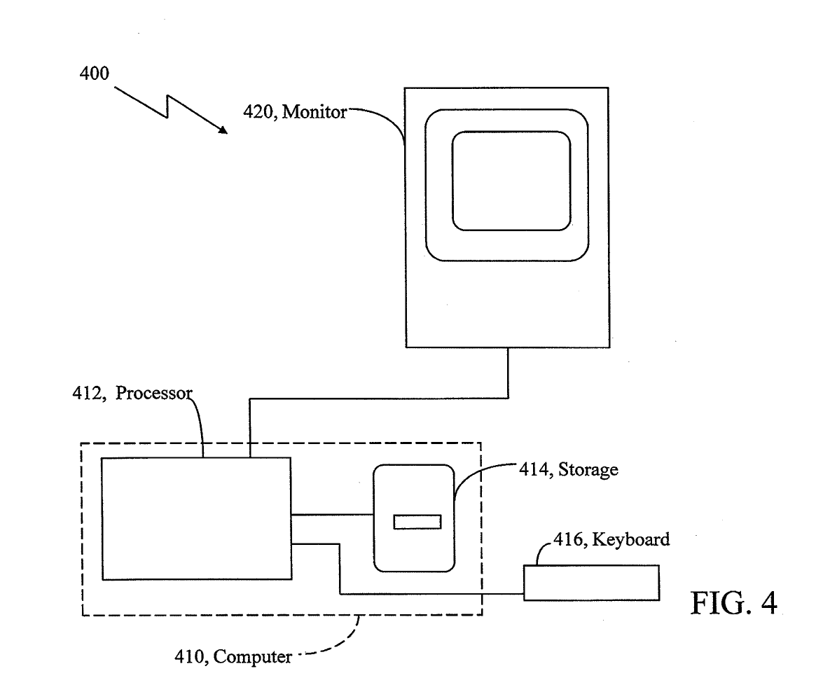

Each of the various systems/components/devices depicted in FIG. 1 may be implemented using a processor-based computing device. Referring to FIG. 4, a schematic diagram of a computing system 400 that may be used in the implementation of any one of the various depicted systems/components/devices of FIG. 1 is shown. The computing system 400 includes a processor-based device 410 such as a desktop or laptop computer, wireless device, a personal computer, a personal digital assistant, a smart phone, a tablet computer, a specialized computing device, a reading machine, and so forth, that typically include a central processor unit 412. In addition to the central processor unit 412, the system includes one or more of the following: main memory, cache memory, bus interface circuits, network interfaces (e.g., wireless and/wired), and a location processor. The processor-based device 410 may also include a mass storage element 414. The computing system 400 may further include an input device, such as a keyboard 416, and a display 420, e.g., a LCD (liquid crystal display) monitor.

The processor-based device 410 is configured to perform some or all of the operations described herein, including operations to generate and/or use master templates to generate documents by entities connected to servers through which the master templates may be accessed, and to maintain and manage the master templates. The storage device 414 may include computer program products that when executed on the processor-based device 410 cause at least some of the operations relating to using, maintaining, and/or managing the master templates.

The processor-based device may further include peripheral devices to enable input/output functionality. Such peripheral devices include, for example, a DVD drive or a network connection, for downloading related content to the connected system. Such peripheral devices may also be used for downloading software containing computer instructions to enable general operation of the respective system/device, and for downloading software implemented programs to perform operations pertaining to the procedures and operations described herein. Alternatively and/or additionally, in some implementations, special purpose logic circuitry, e.g., an FPGA (field programmable gate array) or an ASIC (application-specific integrated circuit) may be used in the implementation of the system 400.

Other modules that may be included with the processor-based device 410 are speakers, a sound card, a pointing device, e.g., a mouse, a trackball, and/or a stylus, by which the user can provide input to the computing system 400. Other kinds of devices can be used to provide for interaction with a user. For example, feedback provided to the user can be any form of sensory feedback, e.g., visual feedback, auditory feedback, or tactile feedback, and input from the user can be received in any form, including acoustic, speech, tactile input, etc. The processor-based device 410 may include an operating system.

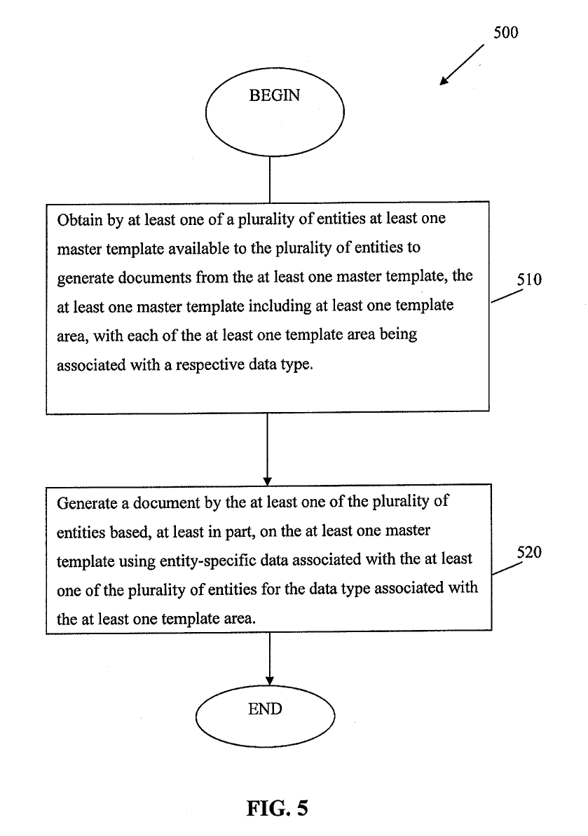

FIG. 5 is a flowchart of an example procedure 500 to maintain, manage, and use master templates is shown. The master templates may, in some embodiments, be stored and managed at a central repository accessible via a cloud by a plurality of different entities (e.g., client machine 110a-n). In some implementations, the client machines 110a-n may each correspond to a separate entity (e.g., a commercial entity). When this is the case, the cloud, implemented, for example, using the servers 120a-n and the database layer 150 shown in FIG. 1, provide separation and privacy of tenant-specific data (e.g., data unique and/or private to a given corporate entity). The procedure 500 includes, in some implementations, obtaining by at least one of a plurality of entities at least one master template available to the plurality of entities to generate documents (e.g., e-mails, reports, letters, facsimile, business documents such as sales orders and invoices, etc.) from the at least one master template. The at least one master template includes at least one template area (e.g., corresponding to a footer area, a header area, and/or other areas of a document), with each of the at least one template area being associated with a respective data type, e.g., a footer data type, a header data type, etc.

The procedure 500 also includes generating a document by the at least one of the plurality of entities based, at least in part, on the at least one master template, and using entity-specific data associated with the at least one of the plurality of entities for the data type associated with the at least one template area. For example, a template for a letter may include pre-configured attributes of the header and footer that may be used enterprise-wide (and thus may be common to several of the plurality of entities authorized to access and use the template in question). Such common features may include, for example, a header area and/or a footer area with pre-defined layout, configuration and formatting attributes. A user associated with one of the plurality of entities may retrieve the partially pre-configured master template and include entity-specific data and attributes. For example, the user may be able to specify a logo used in the header, the content of the footer area, etc.

The subject matter described herein can be implemented in digital electronic circuitry, in computer software, firmware, hardware, or in combinations of them. The subject matter described herein can be implemented as one or more computer program products, i.e., one or more computer programs tangibly embodied in non-transitory media, e.g., in a machine-readable storage device, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Media suitable for embodying computer program instructions and data include all forms of volatile (e.g., random access memory) or non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other in a logical sense and typically interact through a communication network. The relationship of client and server may arise by virtue of computer programs running on the respective computers and having a client-server relationship to each other.

A number of implementations of the invention have been described. Nevertheless, it will be understood that various modifications may be made without departing from the spirit and scope of the invention. Accordingly, other embodiments are within the scope of the following claims.

What is claimed is:

1. A computer-implemented method comprising:
obtaining by at least one of a plurality of entities at least one master template available to the plurality of entities to generate documents from the at least one master template, the at least one master template including at least one template area, each of the at least one template area being associated with a respective data type; and
generating a document by the at least one of the plurality of entities based, at least in part, on the at least one master template using entity-specific data associated with the at least one of the plurality of entities for the data type associated with the at least one template area.

2. The method of claim 1, wherein the plurality of entities comprises a plurality of clients, and wherein the obtaining and the generating are implemented using at least one processor-based device.

3. The method of claim 1, wherein generating the document comprises:
generating the document using at least the at least one master template populated with the data associated with the at least one of the plurality of entities for the data type associated with the at least one template area.

4. The method of claim 3, wherein generating the document comprises:
merging the populated at least one master template with additional raw data provided by the at least one of the plurality of entities.

5. The method of claim 4, wherein the additional raw data is document content.

6. The method of claim 3, wherein the generated document includes at least one of: an e-mail, a facsimile, a form, a report, a business document, and a letter.

7. The method of claim 1, wherein the at least one master template includes information, corresponding to the at least one template area, that is common to at least some of the plurality of entities, the common information including information representative of at least one of: common document layout, common text modules, common coloring formatting, and common document styles.

8. The method of claim 7, wherein the common information of the at least one master template is arranged in a master document such that the entity-specific data is populated directly onto the master document.

9. The method of claim 7, wherein the common information of the at least one master template is arranged as a set of attributes such that a resultant document is generated based, at least in part, on the set of attributes and the entity-specific data.

10. A system comprising:
at least one processor-based device; and
at least one non-transitory memory storage device in communication with the at least one processor-based device, the at least one memory storage device storing computer instructions that, when executed on the at least one processor-based device, cause the at least one processor-based device to:
obtain by at least one of a plurality of entities at least one master template available to the plurality of entities to generate documents from the at least one master template, the at least one master template including at least one template area, each of the at least one template area being associated with a respective data type; and
generate a document by the at least one of the plurality of entities based, at least in part, on the at least one master template using entity-specific data associated with the at least one of the plurality of entities for the data type associated with the at least one template area.

11. The system of claim 10, wherein the computer instructions that cause the at least one processor-based device to generate the document comprise computer instructions that cause the at least one processor-based device to:
generate the document using the at least one master template populated with the data associated with at least one of the plurality of entities for the data type associated with the at least one template area.

12. The system of claim 11, wherein the computer instructions that cause the at least one processor-based device to generate the document using the at least one master template comprise computer instructions that cause the at least one processor-based device to:
merge the populated at least one master template with additional raw data provided by the at least one of the plurality of entities.

13. The system of claim 11, wherein the generated document includes at least one: an e-mail, a facsimile, a form, a report, a business document, and a letter.

14. The system of claim 11, wherein the at least one master template includes information, corresponding to the at least one template area, that is common to at least some of the plurality of entities, the common information including information representative of at least one of: common document layout, common text modules, common coloring formatting, and common document styles.

15. The system of claim 14, wherein the common information of the at least one master template is arranged as at least one of: a master document such that the entity-specific data is populated directly onto the master document, and a set of attributes such that a resultant document is generated based, at least in part, on the set of attributes and the entity-specific data.

16. A computer program product comprising at least one non-transitory computer readable storage device storing computer instructions that, when executed on at least one processor-based device, cause the at least one processor-based device to perform operations comprising:
obtaining by at least one of a plurality of entities at least one master template available to the plurality of entities to generate documents from the at least one master template, the at least one master template including at least one template area, each of the at least one template area being associated with a respective data type; and
generating a document by the at least one of the plurality of entities based, at least in part, on the at least one master template using entity-specific data associated with the at least one of the plurality of entities for the data type associated with the at least one template area.

17. The computer program product of claim 16, wherein the computer instructions that cause the at least one processor-based device to perform the operations of generating the document comprise computer instructions that cause the at least one processor-based device to perform the operations of:
generating the document using the at least one master template populated with the data associated with at least one of the plurality of entities for the data type associated with the at least one template area.

18. The computer program product of claim 17, wherein the computer instructions that cause the at least one processor-based device to perform the operations of generating the document using the at least one master template comprise computer instructions that cause the at least one processor-based device to perform the operations of:
merging the populated at least one master template with additional raw data provided by the at least one of the plurality of entities.

19. The computer program product of claim 17, wherein the generated document includes at least one: an e-mail, a facsimile, a form, a report, a business document, and a letter.

20. The computer program product of claim 16, wherein the at least one master template includes information, corresponding to the at least one template area, that is common to at least some of the plurality of entities, the common information including information representative of at least one of: common document layout, common text modules, common coloring formatting, and common document styles.
